(19) United States
(12) Patent Application Publication
(10) Pub. No.: US 2025/0223438 A1
(43) Pub. Date: Jul. 10, 2025

(54) THERMOPLASTIC RESIN COMPOSITION AND MOLDED BODY CONTAINING SAME

(71) Applicants: HYUNDAI MOTOR COMPANY, Seoul (KR); KIA CORPORATION, Seoul (KR)

(72) Inventors: Yong Beom Lee, Seoul (KR); Choon Ho Lee, Hwaseong-si (KR); Min Sung Kang, Daejeon (KR); Joo Han Lee, Daejeon (KR)

(73) Assignees: HYUNDAI MOTOR COMPANY, Seoul (KR); KIA CORPORATION, Seoul (KR)

(21) Appl. No.: 18/676,084

(22) Filed: May 28, 2024

(30) Foreign Application Priority Data
Jan. 10, 2024 (KR) 10-2024-0004049

(51) Int. Cl. C08L 69/00; C08K 3/34; C08K 5/521; C08K 7/04

(52) U.S. Cl. CPC C08L 69/00; C08K 3/346; C08K 5/521; C08K 7/04; C08L 2201/08; C08L 2205/035; C08L 2207/20

(57) ABSTRACT

A thermoplastic resin composition and a molded body containing the same are disclosed. The resin composition can obtain good dimensional stability and thermal deformation resistance at high temperatures by the introduction of an inorganic filler and an aromatic polyester into a polycarbonate resin and a polycarbonate-polysiloxane copolymer. The resin composition includes: 40 to 80 weight percent (wt %) of a polycarbonate resin; 1 to 20 wt % of a polycarbonate-polysiloxane copolymer resin; 5 to 30 wt % of an aromatic polyester resin; 1 to 20 wt % of a graft copolymer resin in which a rubbery polymer, an aromatic vinyl monomer, and a vinyl cyanide monomer are polymerized through graft polymerization; 5 to 30 wt % of an inorganic filler; 0.01 to 1 wt % of an organophosphate ester compound; and 1 to 5 wt % of a vinyl-based copolymer resin.

### CROSS REFERENCE TO RELATED APPLICATION

The present application claims priority to Korean Patent Application No. 10-2024-0004049, filed Jan. 10, 2024, the entire contents of which is incorporated herein for all purposes by this reference.

### BACKGROUND

### Field of the Disclosure

The present disclosure relates to a thermoplastic resin composition and a molded body containing the same. Specifically, the resin composition can obtain good dimensional stability and thermal deformation resistance at high temperatures by the introduction of an inorganic filler and an aromatic polyester into a polycarbonate resin and a polycarbonate-polysiloxane copolymer.

### Description of the Related Art

Of all thermoplastic resins, acrylonitrile-butadiene-styrene (ABS) resins have excellent mechanical strength, moldability, color realization, and plating properties, and thus are used in a wide range of fields, including automobiles, home appliances, office automation (OA), and the like. However, ABS resins have insufficient heat and impact resistance, so the use thereof is limited. On the other hand, despite excellent heat and impact resistance, polycarbonate resins are characterized in that moldability and impact resistance are poor at low temperatures, making the use thereof limited.

To solve these problems, methods of blending ABS resins and polycarbonate resins to complement the drawbacks of the respective materials are widely used. Specifically, a polycarbonate-ABS (PC-ABS) resin having excellent mechanical strength, moldability, impact resistance, and heat resistance is obtainable by blending an ABS resin and a polycarbonate resin. Such PC-ABS resins are being used in various fields of interior and exterior parts, including automobile interior parts that require stability in the event of a collision.

With the recently strengthened environmental regulations, the market of electric vehicles has been expanding. In this case, electric vehicles typically have a shorter driving range than internal combustion engine vehicles, making it important to obtain the maximum level thereof. In particular, batteries installed in each electric vehicle are significantly heavy, so research is in progress on reducing the weight of parts used in electric vehicles to increase driving range and improve fuel economy or electric economy.

To reduce the weight of parts used in electric vehicles, attempts have been made to replace metal with the PC-ABS resin described above and reduce the thickness of a molded body. However, reducing the thickness leads to problems such as vulnerability to thermal deformation, so efforts should be made to improve quality.

### SUMMARY

The present disclosure, which has been made to solve the problems mentioned above, aims to improve good dimensional stability and thermal deformation resistance at high temperatures by the introduction of an inorganic filler and an aromatic polyester into a thermoplastic resin used in automobiles.

Additionally, the present disclosure aims to obtain interior and exterior parts for automobiles, ships, and construction having excellent mechanical properties and heat resistance by producing a molded body using a thermoplastic resin composition with improved dimensional stability and thermal deformation resistance.

Objectives of the present disclosure are not limited to the objectives mentioned above. The above and other objectives of the present disclosure should become more apparent from the following description and are realized according to the appended claims and combinations thereof.

One aspect of the present disclosure provides a thermoplastic resin composition. The composition includes: 40 to 80 weight percent (wt %) of a polycarbonate resin; 1 to 20 wt % of a polycarbonate-polysiloxane copolymer resin; 5 to 30 wt % of an aromatic polyester resin; 1 to 20 wt % of a graft copolymer resin in which a rubbery polymer, an aromatic vinyl monomer, and a vinyl cyanide monomer are polymerized through graft polymerization; 5 to 30 wt % of an inorganic filler; 0.01 to 1 wt % of an organophosphate ester compound; and 1 to 5 wt % of a vinyl-based copolymer resin.

In one embodiment, the polycarbonate resin may have a melt flow index in a range of 10 to 35 grams per ten minutes (g/10 min) measured according to the ISO 1133 standard at a temperature of 300° C. under a load condition of 1.2 kg.

In one embodiment, at least a portion of the polycarbonate resin may include a post-consumer recycled polycarbonate (PCR-PC) resin. The PCR-PC resin may be contained in an amount of 10 to 30 wt % based on the weight of the composition. The PCR-PC resin may have a melt flow index in a range of 10 to 35 g/10 min measured according to the ISO 1133 standard at a temperature of 300° C. under a load condition of 1.2 kg.

In one embodiment, the polycarbonate-polysiloxane copolymer resin may have a melt flow index in a range of 1 to 10 g/10 min measured according to the ISO 1133 standard at a temperature of 300° C. under a load condition of 1.2 kg.

In one embodiment, the aromatic polyester resin may include at least one selected from the group comprising or consisting of polybutylene terephthalate (PBT), polyethylene terephthalate (PET), polyethylene terephthalate glycol (PETG), or any combination thereof.

In one embodiment, the rubbery polymer of the graft copolymer resin may include a diene-based rubbery polymer.

In this case, the diene-based rubbery polymer may include at least one selected from the group comprising or consisting of polybutadiene, a butadiene-aromatic vinyl compound copolymer, a butadiene-vinyl cyanide compound copolymer, polyisoprene, or any combination thereof. The butadiene-aromatic vinyl compound copolymer may include a butadiene-styrene copolymer and a butadiene-vinyltoluene copolymer. The butadiene-vinyl cyanide compound copolymer may include a butadiene-acrylonitrile copolymer and a butadiene-methacrylonitrile copolymer.

In one embodiment, the graft copolymer resin may include first and second graft copolymer resins. Each of the first and second graft copolymer resins may be contained in the graft copolymer resin in an amount of 1 to 10 wt % based on the total weight of the composition. Additionally, the first graft copolymer resin may be polymerized through graft polymerization of 55 to 65 wt % of a diene-based rubbery polymer and 35 to 45 wt % of a monomer mixture of the aromatic vinyl monomer and the vinyl cyanide monomer. The second graft copolymer resin may be polymerized through graft polymerization of 45 to 55 wt % of a diene-based rubbery polymer and 45 to 55 wt % of a monomer mixture of the aromatic vinyl monomer and the vinyl cyanide monomer.

In this case, the diene-based rubbery polymer may include at least one selected from the group comprising or consisting of polybutadiene, a butadiene-aromatic vinyl compound copolymer, a butadiene-vinyl cyanide compound copolymer, polyisoprene, or any combination thereof. The butadiene-aromatic vinyl compound copolymer may include a butadiene-styrene copolymer and a butadiene-vinyltoluene copolymer. The butadiene-vinyl cyanide compound copolymer may include a butadiene-acrylonitrile copolymer and a butadiene-methacrylonitrile copolymer.

In one embodiment, the first graft copolymer resin may have a graft ratio in a range of 30% to 40%, an average particle diameter in a range of 0.2 to 0.5 micrometer (μm), and a weight average molecular weight in a range of 105,000 to 120,000 grams per mole (g/mol).

In one embodiment, the second graft copolymer resin may have a graft ratio in a range of 40% to 50%, an average particle diameter in a range of 0.05 to 0.15 μm, and a weight average molecular weight in a range of 90,000 to 105,000 g/mol.

In one embodiment, each of the first and second graft copolymer resins may further include 0.1 to 4.0 parts by weight of an initiator based on 100 parts by weight of the diene-based rubbery polymer and the monomer mixture.

In one embodiment, the initiator may include at least one selected from the group comprising or consisting of succinic acid peroxide, benzoyl peroxide, t-butyl peroxy laurate, 2,5-dimethyl-2,5-di(benzoyl peroxy)hexane, t-butyl peroxy acetate, di-t-butyl diperoxy phthalate, t-butyl peroxy maleic acid, cyclohexanone peroxide, t-butyl hydroperoxide, t-butyl peroxy-2-ethyl hexanoate, p-chlorobenzoyl peroxide, t-butyl peroxy isobutyrate, t-butyl peroxy isopropyl carbonate, t-butyl peroxy benzoate, dicumyl peroxide, 2,5-dimethyl-2,5-di(t-butyl-peroxy)hexane, t-butyl cumyl peroxide, di-t-butyl peroxide, 2,5-dimethyl-2,5-di(t-butylperoxy)hexane-3, alpha′-bis-t-butylperoxy-1,4-diisopropylbenzene, or any combination thereof.

In one embodiment, the inorganic filler may include at least one selected from the group comprising or consisting of a needle-shaped inorganic material, a plate-like inorganic material, quicklime, meerschaum, or any combination thereof.

In one embodiment, the needle-shaped inorganic material may include at least one selected from the group comprising or consisting of a whisker, wollastonite, a glass fiber, a basalt fiber, or any combination thereof.

In one embodiment, the plate-like inorganic material may include at least one selected from the group comprising or consisting of talc, mica, kaolin clay, or any combination thereof.

In one embodiment, the organophosphate ester compound may include at least one selected from the group comprising or consisting of a monomeric phosphoric acid ester, a monomeric phosphonic ester, an oligomeric phosphoric acid ester, an oligomeric phosphonic acid ester, a phosphonate amine, a phosphazene, or any combination thereof.

In one embodiment, the vinyl-based copolymer resin may include a copolymer of an aromatic vinyl monomer and a vinyl cyan monomer.

Additionally, the vinyl-based copolymer resin may be polymerized through graft polymerization of one selected from the group comprising or consisting of an anhydride monomer, an acrylate monomer, or any combination thereof in the copolymer of the aromatic vinyl monomer and the vinyl cyan monomer.

In this case, the vinyl-based copolymer resin may be polymerized through graft polymerization of 99.0 to 99.9 mol % of the copolymer of the aromatic vinyl monomer and the vinyl cyan monomer and 0.1 to 1.0 mol % of the one selected from the group comprising or consisting of the anhydride monomer, the acrylate monomer, or any combination thereof.

In one embodiment, the vinyl-based copolymer resin may include at least one selected from the group comprising or consisting of glycidyl methacrylate, methyl methacrylate, ethyl methacrylate, butyl methacrylate, 2-hydroxyethyl methacrylate, or any combination thereof.

Another aspect of the present disclosure provides a molded body containing the composition according to the various embodiments mentioned above.

A thermoplastic resin composition, according to one aspect of the present disclosure, can obtain excellent compatibility and dimensional stability and exhibit thermal deformation resistance at high temperatures by the introduction of an aromatic polyester and an inorganic filler into a polycarbonate resin and a polycarbonate-polysiloxane copolymer resin.

Additionally, according to another aspect of the present disclosure, a molded body containing the thermoplastic resin composition having excellent mechanical properties and heat resistance can be applied to various fields, including interior and exterior parts for automobiles or ships, interior and exterior materials for construction, and the like.

Effects of the present disclosure are not limited to the effects mentioned above. It should be understood that the effects of the present disclosure include all the effects which can be deduced from the following description.

### DESCRIPTION OF THE EMBODIMENTS

The above objectives and other objectives, features, and advantages of the present disclosure should be more readily understood from the following embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those having ordinary skill in the art.

Throughout the drawings, like elements are denoted by like reference numerals. In the accompanying drawings, the dimensions of the structures may be larger than actual size for clarity of the present disclosure. Terms used herein, such as “first”, “second”, etc., may be used to describe various components, but the components are not to be construed as being limited to the terms. These terms are used only for the purpose of distinguishing a component from another component. For example, without departing from the scope of the present disclosure, a first component may be referred to as a second component, and a second component may be also referred to as a first component. The singular expression includes the plural expression unless the context clearly indicates otherwise.

It should be further understood that the terms “comprises”, “includes”, or “has” and variations thereof used herein specify the presence of stated features, regions, integers, steps, operations, elements, and/or components. However, such terms do not preclude the presence or addition of one or more other features, regions, integers, steps, operations, elements, components, and/or combinations thereof. It should also be understood that, when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

As used herein, when a range is described for a variable, the variable should be understood to include all values within the stated range, including the stated endpoints of the range. For example, a range of “5 to 10” includes values of 5, 6, 7, 8, 9, and 10, as well as any subranges such as 6 to 10, 7 to 10, 6 to 9, and 7 to 9. The range should be understood to include any value between reasonable integers within the scope of the stated range, such as 5.5, 6.5, 7.5, 5.5 to 8.5, and 6.5 to 9. Additionally, for example, a range of “10% to 30%” includes values, such as 10%, 11%, 12%, and 13%, and all integers up to and including 30%, as well as any subranges such as 10% to 15%, 12% to 18%, and 20% to 30%. The range should be understood to include any value between reasonable integers within the scope of the stated range, such as 10.5%, 15.5%, and 25.5%.

### Thermoplastic Resin Composition

A thermoplastic resin composition, according to one aspect of the present disclosure, includes: 40 to 80 weight percent (wt %) of a polycarbonate resin; 1 to 20 wt % of a polycarbonate-polysiloxane copolymer resin; 5 to 30 wt % of an aromatic polyester resin; 1 to 20 wt % of a graft copolymer resin in which a rubbery polymer, an aromatic vinyl monomer, and a vinyl cyanide monomer are polymerized through graft polymerization; 5 to 30 wt % of an inorganic filler; 0.01 to 1 wt % of an organophosphate ester compound; and 1 to 5 wt % of a vinyl-based copolymer resin.

Hereinafter, the polycarbonate resin, the polycarbonate-polysiloxane copolymer resin, the aromatic polyester resin, the graft copolymer resin, the inorganic filler, the organophosphate ester compound, the vinyl copolymer resin, and other additives, included in the thermoplastic resin composition, are explained in detail.

### (A) Polycarbonate Resin

The thermoplastic resin composition may include 40 to 80 wt % of the polycarbonate resin. When the amount of the polycarbonate resin is less than 40 wt %, the impact and heat resistance of a finally commercialized molded body containing the thermoplastic resin composition may be poor. When the amount of the polycarbonate resin exceeds 80 wt %, the amounts of the aromatic polyester resin and the inorganic filler in the thermoplastic resin composition are reduced, and moldability and mechanical stiffness may thus be poor.

The polycarbonate resin may be prepared by a method of reacting a diphenol-based compound with phosgene, halogen formate, or carbonic acid diester, including but not limited thereto, and may be prepared by various methods used in the art to which the present disclosure pertains.

In one embodiment, at least a portion of the polycarbonate resin may be a post-consumer recycled polycarbonate (PCR-PC) resin. The PCR-PC resin may mean a product containing plastic that has been discharged after use by the end consumer, recovered from the source, and then mechanically and chemically recycled.

Mechanical recycling may mean crushing the collected plastic, washing and melting the plastic to make a pellet form, and mixing the pellet-form plastic with pure raw materials containing polycarbonate in a predetermined ratio for reuse. Chemical recycling may mean a method of extracting only specific polymers from plastic or recovering specific polymers as pure single-molecular substances for repolymerization.

The polycarbonate resin, recycled through such a process, may have a similar or identical chemical composition to that of a polycarbonate resin produced from petrochemical raw materials.

In the thermoplastic resin composition according to the present disclosure may contain 10 to 30 wt % of the PCR-PC resin. When the amount of the PCR-PC resin is less than 10 wt %, eco-friendliness may be insufficient. When the amount of the PCR-PC resin exceeds 30 wt %, process costs may rise.

In one embodiment, the polycarbonate resin may include at least one selected from the group comprising or consisting of a bisphenol-A-polycarbonate resin, a tetramethyl-polycarbonate resin, a bisphenol-Z-polycarbonate resin, a tetrabromo-polycarbonate resin, a tetraacrylo-polycarbonate resin, or any combination thereof. In one example, the bisphenol-A-polycarbonate resin is used to obtain excellent compatibility and impact resistance.

In one embodiment, the polycarbonate resin may have a weight average molecular weight (Mw) in a range of 10,000 to 40,000. When the weight average molecular weight of the polycarbonate resin is less than 10,000, the impact resistance of the molded body containing the thermoplastic resin composition may be poor. When the weight average molecular weight of the polycarbonate resin exceeds 40,000, the dispersion and elongation of the thermoplastic resin composition may be poor. Additionally, the impact resistance of the molded body containing the thermoplastic resin composition may be poor.

In one example, the polycarbonate resin has a weight average molecular weight in the range of 15,000 to 35,000. When the weight average molecular weight of the polycarbonate resin falls within the above numerical range, the impact resistance and heat resistance temperature of the molded body containing the thermoplastic resin composition may be significantly improved.

In one embodiment, the polycarbonate resin may have a melt flow index in a range of 10 to 35 grams per ten minutes (g/10 min) measured according to the ISO 1133 standard at a temperature of 300° C. under a load condition of 1.2 kg. Additionally, the PCR-PC resin may have a melt flow index in a range of 10 to 35 g/10 min measured according to the ISO 1133 standard at a temperature of 300° C. under a load condition of 1.2 kg.

When the melt flow index of the polycarbonate resin or the PCR-PC resin is less than 10 g/10 min, the flowability of the thermoplastic resin composition may be poor, leading to a deterioration in moldability. When the melt flow index of the polycarbonate resin or the PCR-PC resin exceeds 35 g/10 min, the mechanical properties of the thermoplastic resin composition and the molded body containing the same may deteriorate.

### (B) Polycarbonate-Polysiloxane Copolymer Resin

The thermoplastic resin composition, according to the present disclosure, may include 1 to 20 wt % of the polycarbonate-polysiloxane copolymer resin. When the amount of the polycarbonate-polysiloxane copolymer resin is less than 1 wt %, mold releasability may be poor, and the impact resistance of the finally commercialized plastic molded body may be poor, especially at low temperatures. When the amount of the polycarbonate-polysiloxane copolymer resin exceeds 20 wt %, a decrease in heat-resistant temperature of the thermoplastic resin may lead to a deterioration in thermal deformation resistance.

The polycarbonate-polysiloxane copolymer may be formed by copolymerizing a polycarbonate block and a poly(diorganosiloxane) block. A monomer mixture of polycarbonate block monomers and poly(diorganosiloxane) block monomers mixed in a weight ratio in a range of 70:30 to 90:10 may be copolymerized.

In this case, the poly(diorganosiloxane) block monomers may be contained in the monomer mixture in an amount in a range of 10 to 30 wt %. When the amount of the poly(diorganosiloxane) block monomers is less than 10 wt %, the ductility of the thermoplastic resin may be poor, leading to a deterioration in the surface impact strength of the molded body. When the amount of the poly(diorganosiloxane) block monomers exceeds 30 wt %, the low glass transition temperature of the poly(diorganosiloxane) block may lead to a decrease in the heat resistance temperature of the thermoplastic resin composition.

In one embodiment, the polycarbonate-polysiloxane copolymer resin may have a melt flow index in a range of 1 to 10 g/10 min measured according to the ISO 1133 standard at a temperature of 300° C. under a load condition of 1.2 kg. When the melt flow index of the polycarbonate-polysiloxane copolymer resin is less than 1 g/10 min, the thermoplastic resin composition may have poor flowability, leading to a deterioration in moldability. When the melt flow index of the polycarbonate-polysiloxane copolymer resin exceeds 10 g/10 min, the mechanical properties of the thermoplastic resin composition and molded body containing the same may be deteriorated.

### (C) Aromatic Polyester Resin

The thermoplastic resin composition, according to the present disclosure, may include 5 to 30 wt % of the aromatic polyester resin. When the amount of the aromatic polyester resin is less than 5 wt %, moldability and chemical resistance may be poor.

In one embodiment, the aromatic polyester resin may have an intrinsic viscosity in a range of 0.6 to 1.3 deciliters per gram (dL/g). When the intrinsic viscosity of the aromatic polyester resin does not fall within the above numerical range, the impact strength, tensile strength, heat resistance temperature, light resistance, and chemical resistance of the final molded body may be poor.

The aromatic polyester resin may be typically obtained through polycondensation of terephthalic acid (TPA), isophthalic acid (IPA), 1,2-naphthalenedicarboxylic acid, 1,4-naphthalenedicarboxylic acid, 1,5-naphthalenedicarboxylic acid, 1,6-naphthalenedicarboxylic acid, 1,7-naphthalenedicarboxylic acid, 1,8-naphthalenedicarboxylic acid, 2,3-naphthalenedicarboxylic acid, 2,6-naphthalenedicarboxylic acid, 2,7-naphthalenedicarboxylic acid, dimethyl terephthalate (DMT), an aromatic dicarboxylate in which an acid is substituted with a dimethyl group, dimethyl isophthalate, alkyl esters or dimethyl-1,2-naphthalate of naphthalenedicarboxylic acid, dimethyl-1,5-naphthalate, dimethyl-1,7-naphthalate, dimethyl-1,7-naphthalate, dimethyl-1,8-naphthalate, dimethyl-2,3-naphthalate, dimethyl-2,6-naphthalate, dimethyl-2,7-naphthalate, or any mixture thereof. The aromatic polyester resin may also be obtained through polycondensation of ethylene glycol having 2 to 12 carbon atoms, 1,2-propylene glycol, 1,3-propylene glycol, 2,2-dimethyl-1,3-propanediol, 2,2-dimethyl-1,3-propylene glycol, 1,3-butanediol, 1,4-butanediol, 1,5-pentanediol, 1,6-hexanediol, 1,3-cyclohexane dimethanol, 1,4-cyclohexane dimethanol, or any mixture thereof, which may be easily implemented by those having ordinary skill in the art to which the present disclosure pertains.

The aromatic polyester resin may be a component in which inorganic particles are mixed by an existing method. The inorganic particles may be titanium dioxide (TiO₂), silicon dioxide (SiO₂), or aluminum hydroxide (Al(OH)₃) but are not limited thereto.

In one embodiment, the aromatic polyester resin may include at least one selected from the group comprising or consisting of polybutylene terephthalate (PBT), polyethylene terephthalate (PET), polyethylene terephthalate glycol (PETG), or any combination thereof.

### (D) Graft Copolymer Resin

The thermoplastic resin composition, according to the present disclosure, may include 1 to 20 wt % of the graft copolymer resin in which the rubbery polymer, the aromatic vinyl monomer, and the vinyl cyanide monomer are polymerized through graft polymerization. In this case, the rubbery polymer of the graft copolymer resin may include a diene-based rubbery polymer.

In one embodiment, the diene-based rubbery polymer may include at least one selected from the group comprising or consisting of polybutadiene, a butadiene-aromatic vinyl compound copolymer, a butadiene-vinyl cyanide compound copolymer, polyisoprene, or any combination thereof. The butadiene-aromatic vinyl compound copolymer may include a butadiene-styrene copolymer and a butadiene-vinyltoluene copolymer. The butadiene-vinyl cyanide compound copolymer may include a butadiene-acrylonitrile copolymer and a butadiene-methacrylonitrile copolymer.

The graft copolymer resin includes a first graft copolymer resin and a second graft copolymer resin, each of which is described below.

### (D-1) First Graft Copolymer Resin

The thermoplastic resin composition may include 1 to 10 wt % of the first graft copolymer resin. When the amount of the first graft copolymer resin is less than 1 wt %, impact strength properties may be poor. On the contrary, when the amount of the first graft copolymer resin exceeds 10 wt %, the glass transition temperature of the thermoplastic resin composition may be reduced, leading to a deterioration in heat resistance.

In one embodiment, the first graft copolymer resin may be polymerized through graft polymerization of 55 to 65 wt % of the diene-based rubbery polymer and 35 to 45 wt % of a monomer mixture of the aromatic vinyl monomer and the vinyl cyanide monomer.

The first graft copolymer resin may be polymerized using a known polymerization method such as emulsion polymerization, suspension polymerization, solution polymerization, block polymerization, or a combination of two or more thereof. During graft polymerization, the monomer mixture may be administered to the diene-based rubbery polymer all at once along with a known emulsifier, polymerization initiator, catalyst, and the like, or may be administered continuously for a predetermined period of time, as needed. The graft copolymer resin initially obtained through graft polymerization may be obtained in a latex form or may be obtained in a powdery solid form by treating the resin with acid or salt, followed by coagulating and drying.

The first graft copolymer resin may be prepared by an emulsion polymerization method, which facilitates control of particle diameter, but is not limited thereto. The first graft copolymer resin may be polymerized through graft polymerization of the monomer mixture of the aromatic vinyl monomer and the vinyl cyanide monomer mixed in a weight ratio in a range of 60:40 to 80:20 in the diene-based rubbery polymer. Additionally, the monomer mixture may further include 0 to 20 wt % of a monovinyl monomer based on the total weight of the monomer mixture.

In one embodiment, the vinyl cyanide monomer may be contained in the monomer mixture in an amount of 20 to 40 wt % based on the total weight of the monomer mixture. When the amount of the vinyl cyanide monomer is less than 20 wt %, kneadability and the impact resistance of the final molded body may be significantly poor. When the amount of the vinyl cyanide monomer exceeds 40 wt %, the surface properties may be poor due to yellowing occurring when molding the thermoplastic resin composition at high temperatures. Additionally, kneadability with other resins may be poor.

The monovinyl monomer may include at least one selected from the group comprising or consisting of maleimide, N-methylmaleimide, N-ethylmaleimide, N-propylmaleimide, N-phenylmaleimide, methyl methacrylate, methyl acrylate, butyl acrylate, acrylic acid, maleic anhydride, or any combination thereof, but is not limited thereto.

The first graft copolymer resin may have a graft ratio in a range of 30% to 40%, an average particle diameter in a range of 0.2 to 0.5 micrometer (μm), and a weight average molecular weight in a range of 105,000 to 120,000 grams per mole (g/mol). When the graft ratio of the first graft copolymer resin does not fall within the above numerical range, the dispersion of the thermoplastic resin composition may be reduced, leading to deterioration in moldability and heat resistance properties.

The graft ratio may be derived from Equation 1 below.

$$G ( \% ) = \frac{Mg}{Wc} \times 100 \qquad Equation 1$$

In Equation 1 above, G is the graft ratio (%), M_{g} is the weight (g) of the monomer polymerized through graft polymerization in the rubbery polymer, and W, is the weight (g) of the rubbery polymer.

### (D-2) Second Graft Copolymer Resin

The thermoplastic resin composition may include 1 to 10 wt % of the second graft copolymer resin. When the amount of the second graft copolymer resin is less than 1 wt %, appearance quality, including gloss and color realization, may be poor. When the amount of the second graft copolymer resin exceeds 10 wt %, compatibility with other resins may be poor due to an increase in viscosity, leading to deterioration in mechanical properties.

In one embodiment, the second graft copolymer resin may be polymerized through graft polymerization of 45 to 55 wt % of the diene-based rubbery polymer and 45 to 55 wt % of a monomer mixture of the aromatic vinyl monomer and the vinyl cyanide monomer.

The second graft copolymer resin may be polymerized using a known polymerization method such as emulsion polymerization, suspension polymerization, solution polymerization, block polymerization, or a combination of two or more thereof. During graft polymerization, the monomer mixture may be administered to the diene-based rubbery polymer all at once along with a known emulsifier, polymerization initiator, catalyst, and the like, or may be administered continuously for a predetermined period of time, as needed. The graft copolymer resin initially obtained through graft polymerization may be obtained in a latex form or may be obtained in a powdery solid form by treating the resin with acid or salt, followed by coagulating and drying.

The second graft copolymer resin may be prepared by an emulsion polymerization method, which facilitates control of particle diameter, but is not limited thereto.

The second graft copolymer resin may be polymerized through graft polymerization of the monomer mixture of the aromatic vinyl monomer and the vinyl cyanide monomer mixed in a weight ratio in a range of 60:40 to 80:20 in the diene-based rubbery polymer. Additionally, the monomer mixture may further include 0 to 20 wt % of a monovinyl monomer based on the total weight of the monomer mixture.

In one embodiment, the second graft copolymer resin may have a graft ratio in a range of 40% to 50%, an average particle diameter in a range of 0.05 to 0.15 μm, and a weight average molecular weight in a range of 90,000 to 105,000 g/mol. When the graft ratio of the second graft copolymer resin does not fall within the above numerical range, the dispersion of the thermoplastic resin composition may be reduced, leading to deterioration in moldability and heat resistance properties. On the other hand, the graft ratio may be derived from Equation 1 above.

### (D-3) Initiator

In one embodiment, each of the first and second graft copolymers may further include 0.1 to 4.0 parts by weight of an initiator based on 100 parts by weight of the diene-based rubbery polymer and the monomer mixture.

In one embodiment, the initiator may include at least one selected from the group comprising or consisting of succinic acid peroxide, benzoyl peroxide, t-butyl peroxy laurate, 2,5-dimethyl-2,5-di(benzoyl peroxy)hexane, t-butyl peroxy acetate, di-t-butyl diperoxy phthalate, t-butyl peroxy maleic acid, cyclohexanone peroxide, t-butyl hydroperoxide, t-butyl peroxy-2-ethyl hexanoate, p-chlorobenzoyl peroxide, t-butyl peroxy isobutyrate, t-butyl peroxy isopropyl carbonate, t-butyl peroxy benzoate, dicumyl peroxide, 2,5-dimethyl-2,5-di(t-butyl-peroxy)hexane, t-butyl cumyl peroxide, di-t-butyl peroxide, 2,5-dimethyl-2,5-di(t-butylperoxy)hexane-3, alpha′-bis-t-butylperoxy-1,4-diisopropylbenzene, or any combination thereof.

Additionally, the initiator may include a first initiator containing one peroxide group and a second initiator containing two or more peroxide groups, and the initiator may include the first and second initiators in a weight ratio in a range of 40:60 to 60:40.

### (E) Inorganic Filler

The thermoplastic resin composition, according to the present disclosure, may include 5 to 30 wt % of the inorganic filler. When the amount of the inorganic filler is less than 5 wt %, the dimensional stability of the ultimately commercialized plastic molded body may be low, the heat resistance temperature may be reduced, and mechanical stiffness may be poor. When the amount of the inorganic filler exceeds 30 wt %, poor impact resistance and low fluidity may lead to a deterioration in appearance quality.

In one embodiment, the inorganic filler may include at least one selected from the group comprising or consisting of a needle-shaped inorganic material, a plate-like inorganic material, quicklime, meerschaum, or any combination thereof. The inorganic filler may be a mixture of the needle-shaped inorganic material and the plate-like inorganic material. The inorganic filler may be a mixture of the needle-shaped inorganic material and the plate-like inorganic material in a weight ratio in a range of 30:70 to 70:30.

In one embodiment, the needle-shaped inorganic material may include at least one selected from the group comprising or consisting of a whisker, wollastonite, a glass fiber, a basalt fiber, or any combination thereof.

For example, the whisker may be a potassium titanate whisker, a magnesium sulfate whisker, a calcium carbonate whisker, or an aluminum borate whisker. Additionally, the wollastonite may have been subjected to hydrophobic surface treatment. Furthermore, the glass fiber may be a glass fiber reinforcing agent in which glass filaments coated with a sizing agent, such as epoxy, urethane, or silane, are gathered to form a fiber, but is not limited thereto. In this case, the sizing agent may be contained in an amount of 0.05 to 0.1 parts by weight based on 100 parts by weight of glass filament but is not limited thereto.

Additionally, the needle-shaped inorganic material has a needle-like (fibrous) form and may have an average diameter (D) in a range of 0.1 to 20 μm, which in one example is in the range of 1.0 to 15 μm, and may have an average length (L) in a range of 1 to 3,000 μm, which in one example is in the range of 100 to 3,000 μm. Additionally, an aspect ratio (L/D) of the average length to the average diameter may be in a range of 10 to 200, which in one example is in the range of 20 to 100.

In one embodiment, the plate-like inorganic material may include at least one selected from the group comprising or consisting of talc, mica, kaolin clay, or any combination thereof.

The plate-like inorganic material has a thin film form in which the Z-axis length (thickness) is small compared to the cross-sectional area expressed by the X-axis length and the Y-axis length. The thin film may have an average thickness in a range of 30 to 700 nanometers (nm)), which in one example is in the range of 30 to 300 nm and may have an average particle size in a range of 0.5 to 20 μm, which in one example is in the range of 1.0 to 10.0 μm. Additionally, an aspect ratio (diameter/thickness) of the average diameter (the average value of the X-axis length and the Y-axis length) to the average thickness (Z-axis length) is in a range of 4 to 30, which in one example is in the range of 10 to 30.

The average particle size of the plate-like inorganic material refers to the median value of the particle size distribution measured by X-ray transmission. Specifically, the particle size distribution of the plate-like inorganic material may be obtained by passing the settling particles through X-rays. Then, the average particle size may be obtained by calculating the median value.

### (F) Organophosphate Ester Compound

The thermoplastic resin composition, according to the present disclosure, may include 0.01 to 1 wt % of the organophosphate ester compound. When the amount of the organophosphate compound does not fall within the above numerical range, it may be difficult to suppress the thermal decomposition reaction of the polycarbonate resin generated in the process of producing the molded body and the like. Accordingly, metal ions contained in the inorganic filler to strengthen the dimensional stability of the thermoplastic resin composition accelerate thermal decomposition of the polycarbonate resin, leading to deterioration in impact resistance, dimensional stability, and appearance quality.

In one embodiment, the organophosphate ester compound may include at least one selected from the group comprising or consisting of a monomeric phosphoric acid ester, a monomeric phosphonic ester, an oligomeric phosphoric acid ester, an oligomeric phosphonic acid ester, a phosphonate amine, a phosphazene, or any combination thereof, but is not limited thereto.

### (G) Vinyl-Based Copolymer Resin

The thermoplastic resin composition, according to the present disclosure, may include 1 to 5 wt % of the vinyl-based copolymer resin. When the amount of the vinyl-based copolymer resin is less than 1 wt %, compatibility between the polycarbonate resin and the graft copolymer resin may be poor, leading to deterioration in mechanical properties, including impact resistance properties. When the amount of the vinyl-based copolymer resin exceeds 5 wt %, an increase in the viscosity of the thermoplastic resin may lead to a deterioration in moldability.

In one embodiment, the vinyl-based copolymer resin may include a copolymer of an aromatic vinyl monomer and a vinyl cyan monomer.

Additionally, the vinyl-based copolymer resin may be polymerized through graft polymerization of one selected from the group comprising or consisting of an anhydride monomer, an acrylate monomer, or any combination thereof in the copolymer of the aromatic vinyl monomer and the vinyl cyan monomer, but is not limited thereto.

In this case, the vinyl-based copolymer resin may be polymerized through graft polymerization of 99.0 to 99.9 mol % of the copolymer of the aromatic vinyl monomer and the vinyl cyan monomer and 0.1 to 1.0 mol % of the one selected from the group comprising or consisting of the anhydride monomer, the acrylate monomer, or any combination thereof.

The anhydride monomer may include at least one selected from the group comprising or consisting of maleic anhydride, 2-methyl-maleic anhydride, 2,3-dimethyl-maleic anhydride, 2-ethyl-maleic anhydride, 2,3-diethyl-maleic anhydride, 2-trifluoromethyl-maleic anhydride, 2,3-bis(trifluoromethyl)-maleic anhydride, 2-methyl-3-trifluoromethyl-maleic anhydride, citraconic anhydride, aconitic anhydride, itaconic anhydride, or any combination thereof, but is not limited thereto.

The acrylate monomer may include at least one selected from the group comprising or consisting of glycidyl methacrylate, methyl methacrylate, ethyl methacrylate, butyl methacrylate, 2-hydroxyethyl methacrylate, or any combination thereof, but is not limited thereto.

### (H) Additives

The thermoplastic resin composition may further include other additives, as needed.

The additives, used to additionally provide various functions to the thermoplastic resin composition, may include at least one selected from the group comprising or consisting of a commonly used stabilizer, a lubricant, a metallic soap, an ultraviolet absorber, a plasticizer, a colorant (pigment and dye), a glass fiber, a filler (silica, wood powder, and the like), a flame retardant, an anti-drip agent, an antibacterial agent, an anti-fungal agent, or any combination thereof, but are not limited thereto.

In particular, the flame retardant may provide flame retardancy to thermoplastic resin compositions whose heat resistance and combustion resistance are poor and may be classified, depending on components, into halogen-based, inorganic, phosphorus-based, and melanin-based flame retardants.

The halogen-based flame retardant may be classified into bromine-based and chlorine-based flame retardants. The bromine-based flame retardants may provide excellent flame retardant effects even in small amounts, but plastics are unrecyclable, and toxic environmental pollutants, such as dioxins, may be discharged when burned.

The inorganic flame retardant may include, for example, aluminum hydroxide, antimony oxide, magnesium hydroxide, zinc stannate, molybdate, guanidine, zirconium, and the like. Such aluminum hydroxide is non-toxic, low in smoke, has excellent electrical insulation, and is affordable, but the decomposition temperature thereof ranges from 180° C. to 220° C. For this reason, aluminum hydroxide is only applicable to plastics having low processing temperatures. Additionally, the mechanical properties and processability of plastic materials may deteriorate because large quantities are required to provide flame retardancy.

The phosphorus-based flame retardant may include, for example, red phosphorus, ammonium phosphate, ammonium polyphosphate, haloalkyl phosphate, and the like. The phosphorus-based flame retardant exhibits excellent flame retardant effects in solid-state reactions and may be particularly effective for plastics containing a large amount of oxygen.

The melanin-based flame retardant may include, for example, melanin phosphate, melanin cyanurate, and the like. The melanin-based flame retardant does not generate toxic gases and generates less smoke during combustion, thus reducing the risk of environmental pollution.

As described above, the thermoplastic resin composition, according to the present disclosure, has improved plating properties, such as conductivity, plating adhesion, and appearance. Accordingly, a separate electroless plating process may be omitted during plating, thus improving eco-friendliness and plating process efficiency. At the same time, the thermoplastic resin composition exhibits excellent impact strength and thus is available as a suitable material for interior and exterior materials of automobiles.

### Plastic Molded Body

Another aspect of the present disclosure provides a molded body containing the composition according to the various embodiments mentioned above. In other words, the molded body may be prepared by molding the thermoplastic resin composition.

The molded body is applicable for various fields, including automobiles, ships, and interior and exterior materials for construction, depending on the purpose.

In one embodiment, the molded body may have an Izod impact strength (according to ISO 180) in a range of 5 to 20 joule per square meter (J/m²), a tensile strength (according to ISO 527) in a range of 50 to 70 megapascal (Mpa), a heat resistance temperature (at 1.8 MPa, according to ISO 75) in a range of 110° C. to 120° C., a flexural strength (according to ISO 178) in a range of 75 to 95 MPa, and a flexural modulus (according to ISO 178) in a range of 2,500 to 3,500 MPa.

Hereinafter, the present disclosure is described in detail with reference to the following examples and comparative examples. However, the technical idea of the present disclosure is not limited or restricted thereto.

### Examples 1-5 and Comparative Examples 1-7

(A-1) A polycarbonate resin, (A-2) a post-consumer recycled polycarbonate (PCR-PC) resin, (B) a polycarbonate-polysiloxane copolymer resin, (C) an aromatic polyester resin, (D-1) a first graft copolymer resin, (D-2) a second graft resin, (E) an inorganic filler, (F) an organophosphate ester compound, and (G) a vinyl copolymer resin were mixed according to composition ratios as shown in Table 1 below.

Then, the resulting product was subjected to melt kneading (at a cylinder setting temperature of 250° C.) using an extruder having a screw diameter ϕ of 30 mm and an L/D ratio of 44 and then cut to prepare a thermoplastic resin composition in a pellet form.

The specific composition used in the process of preparing the thermoplastic resin composition is as follows:
(A-1) The polycarbonate resin (PC-1220S purchased from LOTTE Chemical) having a melt flow index of about 22 g/10 min measured according to the ISO 1133 standard at a temperature of 300° C. under a load condition of 1.2 kg;
(A-2) The PCR-PC resin (PC-T20 purchased from Topcentral) having a melt flow index of about 22 g/10 min measured according to the ISO 1133 standard at a temperature of 300° C. under a load condition of 1.2 kg;
(B) The polycarbonate-polysiloxane copolymer resin (CLARNATE®S2060 purchased from Wanhua) having a melt flow index of about 2 g/10 min measured according to the ISO 1133 standard at a temperature of 300° C. under a load condition of 1.2 kg;
(C) The polyethylene terephthalate resin (FHH22130 purchased from Toray) having an intrinsic viscosity of 0.8 dL/g according to the ISO 1628 standard;
(D-1) The first graft copolymer resin (purchased from Kumho Petrochemical) polymerized through emulsion graft polymerization of 59 wt % of a diene-based rubbery polymer and 41 wt % of a monomer mixture of an aromatic vinyl monomer and a vinyl cyanide monomer mixed in a weight ratio of 75:25, the first graft copolymer resin having a graft ratio of 35% and a weight average molecular weight of 110,000 g/mol;
(D-2) The second graft copolymer resin (purchased from Kumho Petrochemical) polymerized through emulsion graft polymerization of 50 wt % of a diene-based rubbery polymer and 50 wt % of a monomer mixture of an aromatic vinyl monomer and a vinyl cyanide monomer mixed in a weight ratio of 75:25, the second graft copolymer resin having a graft ratio of 45% and a weight average molecular weight of 100,000 g/mol;
(E) Talc (KC2000C purchased from Kotz) having a median particle size (D50) of about 4.5 μm measured by a laser particle size analyzer (Mastersizer 3000 purchased from Malvern Panalytical);
(F) Stearyl phosphate (ADK STAB AX-71 purchased from Adeka); and
(G) An aromatic vinyl monomer, a vinyl cyan monomer, and a glycidyl methacrylate copolymer resin (SAG-005 purchased from Fine-blend Polymer).

TABLE 1

| | Examples | | | | | Comparative Examples | | | | | | |
|---|---|---|---|---|---|---|---|---|---|---|---|---|
| | 1 | 2 | 3 | 4 | 5 | 1 | 2 | 3 | 4 | 5 | 6 | 7 |
| (A-1) | 60 | 30 | 56 | 53 | 55 | 65 | 40 | 60 | 62 | 28 | 70 | 75 |
| (A-2) | — | 30 | — | — | — | — | — | — | — | — | — | — |
| (B) | 5 | 5 | 15 | 5 | 5 | — | 25 | 5 | 5 | 5 | 5 | 5 |
| (C) | 8 | 8 | 8 | 15 | 8 | 8 | 8 | 8 | 8 | 40 | 8 | 8 |
| (D-1) | 5 | 5 | 2 | 5 | 5 | 5 | 5 | 5 | 5 | 5 | — | 5 |
| (D-2) | 5 | 5 | 2 | 5 | 5 | 5 | 5 | 5 | 5 | 5 | — | 5 |
| (E) | 15 | 15 | 15 | 15 | 20 | 15 | 15 | 15 | 15 | 15 | 15 | — |
| (F) | 0.2 | 0.2 | 0.2 | 0.5 | 0.2 | 0.2 | 0.2 | — | 0.2 | 0.2 | 0.2 | 0.2 |
| (G) | 2 | 2 | 2 | 2 | 2 | 2 | 2 | 2 | — | 2 | 2 | 2 |

(unit: wt %)

### Experiment Example

To evaluate the physical properties of the thermoplastic resin compositions prepared in Examples 1-5 and Comparative Examples 1-7, specimens of the thermoplastic resin composition were prepared using an injection molding machine under a condition where a cylinder setting temperature was 260° C., and a mold temperature was 80° C. Then, the physical properties of each specimen were evaluated by the following methods:
Impact strength (kJ/m²): evaluated in terms of Izod impact strength according to ISO 180;
Tensile strength (MPa): measured according to ISO 527;
Heat resistance temperature (at 1.8 MPa, ° C.): measured in terms of heat deflection temperature according to ISO 75;
Flexural strength (MPa): measured according to ISO 178;
Flexural modulus (MPa): measured according to ISO 178; and
Dimensional stability (μm/m*° C.), measured in terms of linear expansion coefficient at a temperature in a range of −30° C. to 100° C. using a thermomechanical analyzer in the direction of resin flow according to ISO 11359, where the lower the linear expansion coefficient, the better the dimensional stability.

TABLE 2

| | Examples | | | | | Comparative Examples | | | | | | |
|---|---|---|---|---|---|---|---|---|---|---|---|---|
| | 1 | 2 | 3 | 4 | 5 | 1 | 2 | 3 | 4 | 5 | 6 | 7 |
| Impact strength | 7 | 8 | 13 | 6 | 6 | 3 | 17 | 6 | 3 | 3 | 2 | 13 |
| at LT (−30° C.) | | | | | | | | | | | | |
| Impact strength | 10 | 11 | 15 | 8 | 7 | 5 | 20 | 7 | 4 | 4 | 3 | 15 |
| at RT (25° C.) | | | | | | | | | | | | |
| Tensile strength | 62 | 61 | 58 | 57 | 65 | 64 | 50 | 57 | 68 | 51 | 65 | 50 |
| Heat resistance | 117 | 116 | 115 | 115 | 117 | 118 | 110 | 113 | 116 | 108 | 118 | 113 |
| temperature | | | | | | | | | | | | |
| Flexural strength | 82 | 81 | 79 | 78 | 84 | 84 | 75 | 77 | 78 | 72 | 85 | 75 |
| Flexural modulus | 3253 | 3321 | 3118 | 3107 | 3283 | 3314 | 2856 | 2956 | 3107 | 2755 | 3351 | 2656 |
| Linear expansion | 50 | 48 | 49 | 49 | 43 | 47 | 58 | 49 | 55 | 59 | 48 | 67 |
| coefficient | | | | | | | | | | | | |

From Tables 1 and 2 above, it was confirmed that excellent heat resistance temperature and mechanical stiffness were exhibited by using optimal amounts of the polycarbonate resin, the polycarbonate-polysiloxane copolymer resin, the aromatic polyester resin, the graft copolymer resin, the inorganic filler, and the organophosphate ester compound.

Additionally, it was confirmed that the dimensional stability was improved while maintaining a low linear expansion coefficient.

Additionally, even though the PCR-PC resin was applied to the thermoplastic resin composition, it was confirmed that there were no changes in heat resistance temperature, mechanical stiffness, and linear expansion coefficient.

Although embodiments of the present disclosure have been disclosed for illustrative purposes, those having ordinary skill in the art will appreciate that diverse variations and modifications are possible through addition, alteration, deletion, etc. of elements, without departing from the spirit and scope of the present disclosure.

What is claimed is:

1. A thermoplastic resin composition, the composition comprising:
40 to 80 weight percent (wt %) of a polycarbonate resin;
1 to 20 wt % of a polycarbonate-polysiloxane copolymer resin;
5 to 30 wt % of an aromatic polyester resin;
1 to 20 wt % of a graft copolymer resin in which a rubbery polymer, an aromatic vinyl monomer, and a vinyl cyanide monomer are polymerized through graft polymerization;
5 to 30 wt % of an inorganic filler;
0.01 to 1 wt % of an organophosphate ester compound; and
1 to 5 wt % of a vinyl-based copolymer resin.

2. The composition of claim 1, wherein the polycarbonate resin has a melt flow index in a range of 10 to 35 grams per ten minutes (g/10 min) measured according to the ISO 1133 standard at a temperature of 300° C. under a load condition of 1.2 kg.

3. The composition of claim 1, wherein:
at least a portion of the polycarbonate resin comprises a post-consumer recycled polycarbonate (PCR-PC) resin;
the PCR-PC resin is contained in an amount of 10 to 30 wt % based on the weight of the composition; and
the PCR-PC resin has a melt flow index in a range of 10 to 35 g/10 min measured according to the ISO 1133 standard at a temperature of 300° C. under a load condition of 1.2 kg.

4. The composition of claim 1, wherein the polycarbonate-polysiloxane copolymer resin has a melt flow index in a range of 1 to 10 g/10 min measured according to the ISO 1133 standard at a temperature of 300° C. under a load condition of 1.2 kg.

5. The composition of claim 1, wherein the aromatic polyester resin comprises polybutylene terephthalate (PBT), polyethylene terephthalate (PET), polyethylene terephthalate glycol (PETG), or any combination thereof.

6. The composition of claim 1, wherein the rubbery polymer of the graft copolymer resin comprises a diene-based rubbery polymer.

7. The composition of claim 6, wherein:
the diene-based rubbery polymer comprises polybutadiene, a butadiene-aromatic vinyl compound copolymer, a butadiene-vinyl cyanide compound copolymer, polyisoprene, or any combination thereof;
the butadiene-aromatic vinyl compound copolymer comprises a butadiene-styrene copolymer and a butadiene-vinyltoluene copolymer; and
the butadiene-vinyl cyanide compound copolymer comprises a butadiene-acrylonitrile copolymer and a butadiene-methacrylonitrile copolymer.

8. The composition of claim 1, wherein:
the graft copolymer resin comprises a first graft copolymer resin and a second graft copolymer resin;
each of the first and second graft copolymer resins is comprised in the graft copolymer resin in an amount of 1 to 10 wt % based on the total weight of the composition;
the first graft copolymer resin is polymerized through graft polymerization of 55 to 65 wt % of a diene-based rubbery polymer and 35 to 45 wt % of a monomer mixture of the aromatic vinyl monomer and the vinyl cyanide monomer and
the second graft copolymer resin is polymerized through graft polymerization of 45 to 55 wt % of a diene-based rubbery polymer and 45 to 55 wt % of a monomer mixture of the aromatic vinyl monomer and the vinyl cyanide monomer.

9. The composition of claim 8, wherein:
the diene-based rubbery polymer comprises polybutadiene, a butadiene-aromatic vinyl compound copolymer, a butadiene-vinyl cyanide compound copolymer, polyisoprene, or any combination thereof;
the butadiene-aromatic vinyl compound copolymer comprises a butadiene-styrene copolymer and a butadiene-vinyltoluene copolymer; and
the butadiene-vinyl cyanide compound copolymer comprises a butadiene-acrylonitrile copolymer and a butadiene-methacrylonitrile copolymer.

10. The composition of claim 8, wherein the first graft copolymer resin has a graft ratio in a range of 30% to 40%, an average particle diameter in a range of 0.2 to 0.5 micrometer (μm), and a weight average molecular weight in a range of 105,000 to 120,000 grams per mole (g/mol).

11. The composition of claim 8, wherein the second graft copolymer resin has a graft ratio in a range of 40% to 50%, an average particle diameter in a range of 0.05 to 0.15 μm, and a weight average molecular weight in a range of 90,000 to 105,000 g/mol.

12. The composition of claim 8, wherein each of the first and second graft copolymer resins further comprises 0.1 to 4.0 parts by weight of an initiator based on 100 parts by weight of the diene-based rubbery polymer and the monomer mixture of the aromatic vinyl monomer.

13. The composition of claim 12, wherein the initiator comprises succinic acid peroxide, benzoyl peroxide, t-butyl peroxy laurate, 2,5-dimethyl-2,5-di(benzoyl peroxy)hexane, t-butyl peroxy acetate, di-t-butyl diperoxy phthalate, t-butyl peroxy maleic acid, cyclohexanone peroxide, t-butyl hydroperoxide, t-butyl peroxy-2-ethyl hexanoate, p-chlorobenzoyl peroxide, t-butyl peroxy isobutyrate, t-butyl peroxy isopropyl carbonate, t-butyl peroxy benzoate, dicumyl peroxide, 2,5-dimethyl-2,5-di(t-butyl-peroxy) hexane, t-butyl cumyl peroxide, di-t-butyl peroxide, 2,5-dimethyl-2,5-di(t-butylperoxy)hexane-3, alpha′-bis-t-butylperoxy-1,4-diisopropylbenzene, or any combination thereof.

14. The composition of claim 1, wherein the inorganic filler comprises a needle-shaped inorganic material, a plate-like inorganic material, quicklime, meerschaum, or any combination thereof.

15. The composition of claim 14, wherein the needle-shaped inorganic material comprises a whisker, wollastonite, a glass fiber, a basalt fiber, or any combination thereof.

16. The composition of claim 14, wherein the plate-like inorganic material comprises talc, mica, kaolin clay, or any combination thereof.

17. The composition of claim 1, wherein the organophosphate ester compound comprises a monomeric phosphoric acid ester, a monomeric phosphonic ester, an oligomeric phosphoric acid ester, an oligomeric phosphonic acid ester, a phosphonate amine, a phosphazene, or any combination thereof.

18. The composition of claim 1, wherein the vinyl-based copolymer resin comprises a copolymer of an aromatic vinyl monomer and a vinyl cyan monomer.

19. The composition of claim 18, wherein the vinyl-based copolymer resin is polymerized through graft polymerization of an anhydride monomer, an acrylate monomer, or any combination thereof in the copolymer of the aromatic vinyl monomer and the vinyl cyan monomer.

20. The composition of claim 19, wherein the vinyl-based copolymer resin is polymerized through graft polymerization of 99.0 to 99.9 mol % of the copolymer of the aromatic vinyl monomer and the vinyl cyan monomer and 0.1 to 1.0 mol % of the anhydride monomer, the acrylate monomer, or any combination thereof.

21. The composition of claim 1, wherein the vinyl-based copolymer resin comprises glycidyl methacrylate, methyl methacrylate, ethyl methacrylate, butyl methacrylate, 2-hydroxyethyl methacrylate, or any combination thereof.

22. A molded body comprising the composition of claim 1.
